(19) United States
(12) Patent Application Publication
(10) Pub. No.: US 2017/0121990 A1
(43) Pub. Date: May 4, 2017

(54) SYSTEM, METHOD FOR CONVERSION OF INTERMODAL SHIPPING CONTAINERS TO UNIVERSAL BUILDING MODULES

(71) Applicants: Stevan Miller Armstrong, Brentwood, TN (US); David Ray Cross, Charleston, SC (US)

(72) Inventors: Stevan Miller Armstrong, Brentwood, TN (US); David Ray Cross, Charleston, SC (US)

(21) Appl. No.: 15/341,720

(22) Filed: Nov. 2, 2016

Related U.S. Application Data
(60) Provisional application No. 62/249,652, filed on Nov. 2, 2015.

(51) Int. Cl. E04H 1/00; E06B 1/04; E04B 1/343; E04H 1/12; E04B 1/348

(52) U.S. Cl. CPC E04H 1/005; E04H 1/1205; E04B 1/34807; E04B 1/34321; E04B 1/34331; E06B 1/04; E04H 2001/1283

(57) ABSTRACT

Conversion of intermodal shipping containers to a Universal Building Modules for construction industry. The intermodal shipping container is modified to have a plurality of common, framed apertures, adapted to receive a standardized infill panel to define a configurable and reconfigurable structural module.

### CROSS-REFERENCE TO RELATED APPLICATION

This application claims the benefit of priority of U.S. provisional application No. 62/249,652, filed Nov. 2, 2015, the contents of which are herein incorporated by reference.

### BACKGROUND OF THE INVENTION

The present invention relates to modular construction of a structure, and more particularly to prefabricated modular construction of a structure utilizing converted shipping containers.

When using shipping containers for construction of structures, such as office buildings each container used must be analyzed separately for structural code compliance when modified and then custom fabricated. Having to custom design and fabricate every container used in a construction project as is currently done is not practical to demonstrate compliance with international shipping and building standards. Currently, every module is unique and therefore requires detailed review by Building Departments.

As can be seen, there is a need for having universal standardized modules and modifications as well as completely interchangeable infill panels. Having such standardized modules reduces the time it takes to obtain approvals and provides a consistent design and fabrication approach. Having universal modules that are already proven to be code compliant and manufactured in a controlled environment will expedite reviews and reduce design and construction times and errors.

### SUMMARY OF THE INVENTION

In one aspect of the present invention, a structure building module is formed from an intermodal shipping container having one or more primary apertures defined therein. A frame surrounds the primary aperture and the fame is defined by a plurality of structural support members. An infill panel is received in at least one of the frames.

In some embodiments, the infill panel is configured with a window opening. A window assembly may then be received in the window opening. In other embodiments, the infill panel may be configured with a door opening. A door assembly may be received within the door opening.

For interchangeability of components each of the primary apertures may have a corresponding dimension and the infill panels are dimensioned to fit the one or more primary apertures. Preferably, the infill panel is configured with a standardized cooperating fastener arrangement such that the infill panel may be interchangeably secured in the one or more primary apertures. In other aspects of the invention, a plurality of intermodal shipping containers may configured for interconnection to each other.

Other aspects of the invention include a method of forming a building structure from an intermodal shipping container. The method includes modifying the intermodal shipping container by creating one or more primary apertures in a sidewall of the intermodal shipping container. A plurality of frame members are attached to frame the one or more primary apertures. An infill panel is formed, and is dimensioned to be received in the one or more primary apertures. At least one infill panel may be installed in the one or more primary apertures. Preferably, a standardized fastener pattern is formed in in the plurality of frame members. The infill panel may be made with a corresponding fastener pattern, wherein the corresponding fastener pattern is configured for cooperative engagement of a fastener with the standardized fastener pattern of the frame members.

Other aspects of the method include forming one of a door opening or a window opening in a surface of the infill panel. Preferably one of a door assembly or a window assembly are installed in the associated door or the window opening. Preferred aspects of the method include forming a plurality of interchangeable infill panels, wherein each of the plurality of interchangeable infill panels have dimensions corresponding to the one or more primary apertures.

Yet other aspects of the method according to the present invention include joining a plurality of modified intermodal shipping containers to form a larger building structure. The shipping containers jay be joined by aligning the primary apertures of a first intermodal shipping container so as to overlap at least a portion of the primary apertures of a subsequent intermodal shipping container.

These and other features, aspects and advantages of the present invention will become better understood with reference to the following drawings, description and claims.

### BRIEF DESCRIPTION OF THE DRAWINGS

FIG. 1 is a perspective view of a shipping container.

FIG. 2 is a perspective view of the shipping container shown with a panel removed.

FIG. 3 is a perspective view of the invention shown with structural framing.

FIG. 4 is a detail perspective view of a channel structural framing member.

FIG. 5 is a side view of a modified shipping container according to aspects of the invention.

FIG. 6 is an exploded view of the invention shown in exemplary modification with a wall, a window, and a door panel.

FIG. 7 is an exploded view of the invention demonstrating a container combination.

FIG. 8 is a section detail view of the invention taken along line 6-6 in FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a standard universal building module (SGUBM) that eliminates the need to analyze every intermodal shipping container used for a conversion process and reduces the amount of fabrication that must be done either on site or at the factory by creating a universal building block component that can be assembled into a wide variety of floor plan layouts according to the intended use of the converted shipping container.

Currently every container used in a building design must be custom designed and fabricated. By using a universal module with consistent and interchangeable components we reduced the amount of design and fabrication time and still take advantage of the shipping container for its maritime or overland transport use.

Building codes used by building departments are very rigorous and rely heavily on standard products and applications. For container based projects there is no consistency of design and control of quality and workmanship. Having universal modules that are already proven to be code compliant and manufactured in a controlled environment will expedite reviews and reduce design and construction times and errors.

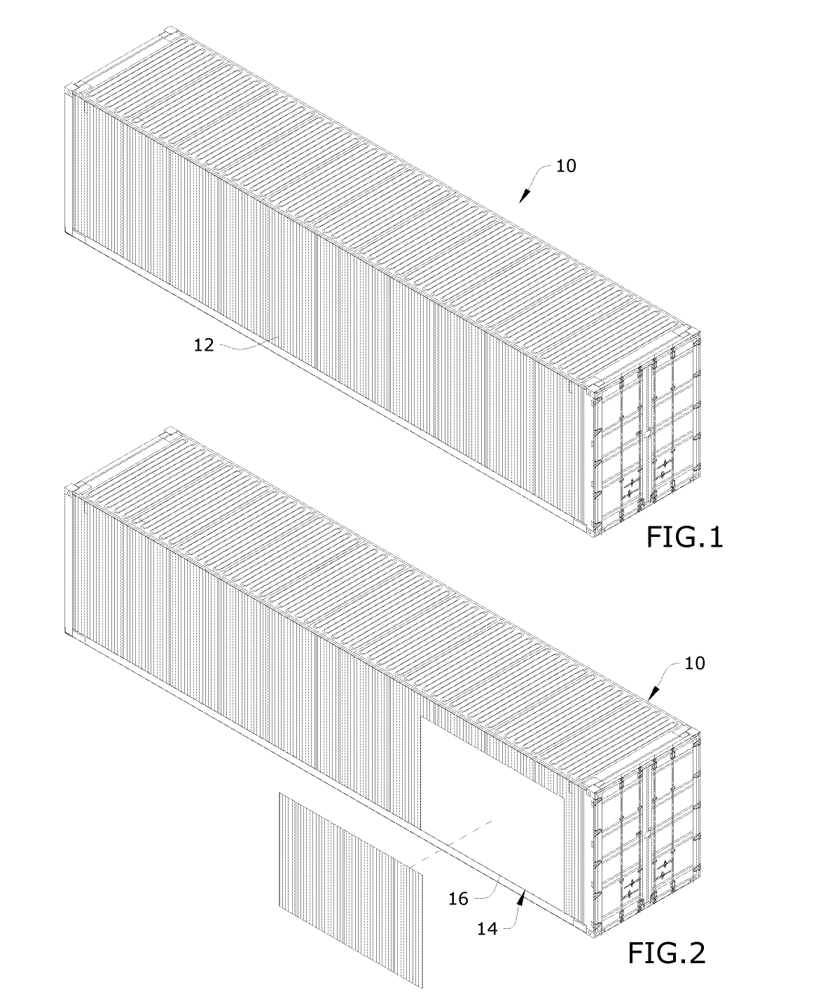

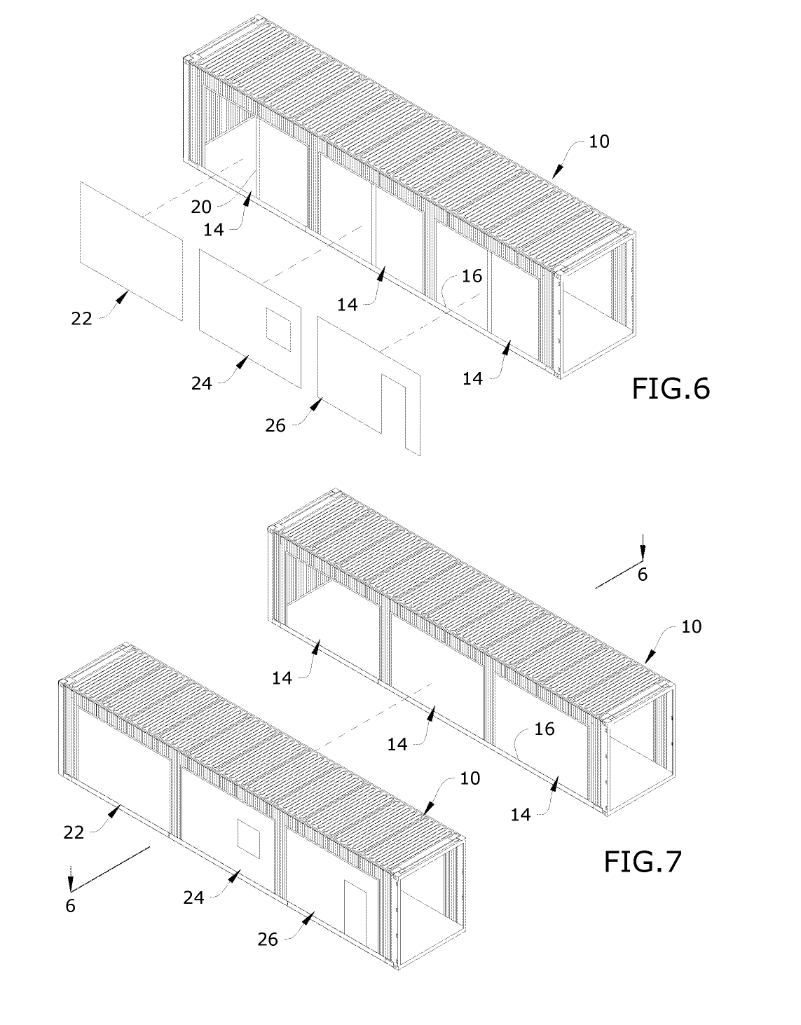

A preferred embodiment of the present invention includes: an intermodal shipping container 10, which may be 40′ intermodal shipping container, such as shown in reference to FIG. 1, rolled steel framing members 20, such as seen in reference to FIG. 4, and standardized size infill panels to insert into the openings formed in the shipping container, as may be seen in reference to FIGS. 6 and 7.

The international intermodal shipping container 10 of FIG. 1 is heavily standardized by international agreement and worldwide specification called the Convention for Safe Containers (CSC) which provides detailed specifications and performance standards for every shipping container to be used in the international maritime fleet.

The SG Universal Building Module (SGUBM) uses the rigorous CSC set of standards as a starting point for the development of building modules. According to aspects of the invention, the SGUBM may be a mass produced standard module with side 14 and end wall cutouts, or apertures that are the same for every module, or a specified module type (which may have additional specifications and requirements based on its intended use).

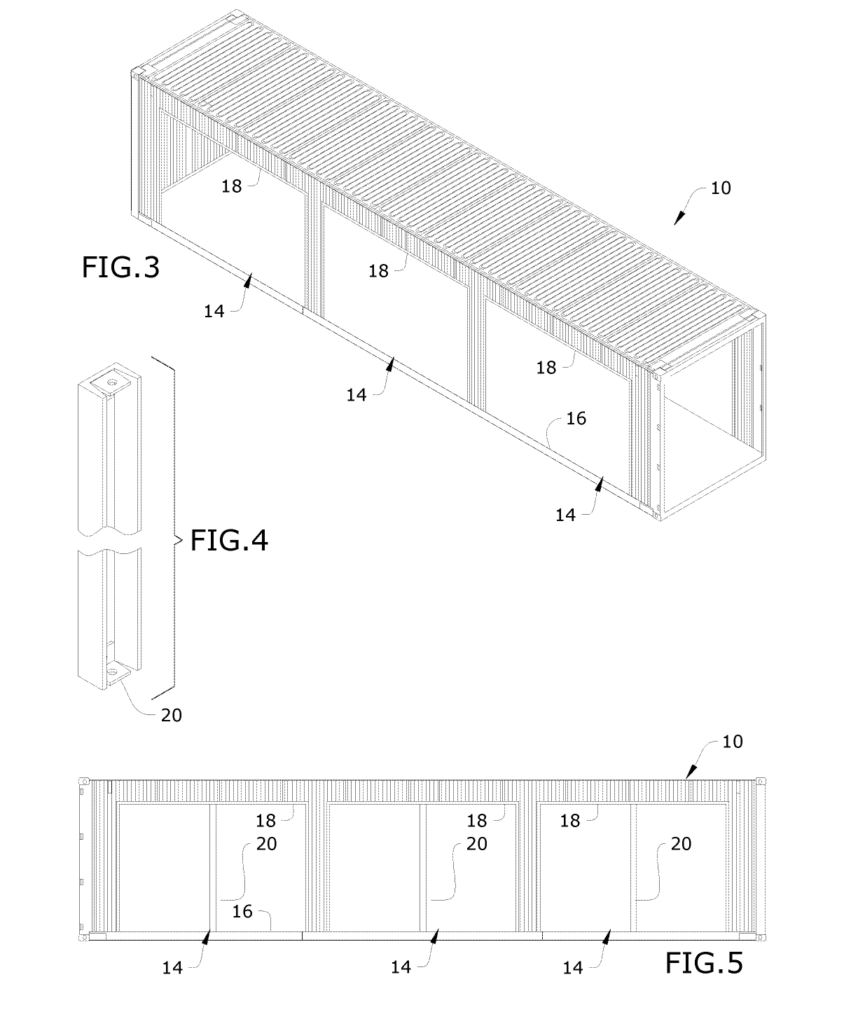

As seen in reference to FIG. 2, the container 10 is modified by creating a plurality of apertures 14 or openings in the side walls of the shipping container 10. In reference to FIG. 3, each opening 14 made in the SGUBM may be framed with rolled steel tube or plate steel members 18 and 16 to reinforce the openings 14 in the sidewalls. By way of example, the top 18 and bottom rails 16 of the container 10 may be reinforced with a double plate steel and beam sections on the bottom 16 and top 18 rails respectively. In addition a vertical frame member 20 may be configured within the opening 14 proximal to a midpoint thereof. The vertical sides to the openings 14 may also be modified with a support beam, to form a finished structural shell, as may be seen in reference to FIGS. 3 and 5. The openings 14 are each dimensioned to a corresponding size to receive one or more of an interchangeable infill panel 22, 24, 26.

As seen in reference to FIGS. 6 and 7, the interchangeable infill panels 22, 24, and 26 may be received within the framed openings 14 allowing for a variety of configurable and reconfigurable building layout options. The infill panels may be secured to the framed openings 14 with any suitable fastener, such as bolts, screws, or welds. Preferably, each of the infill panels, 22, 24, 26 have the same dimensions and correspond to being received in the openings 14 and each of the infill panels 22, 24, 26 . Similarly, each of the framed openings 14 and infill panels 22, 24, 26 may be configured with a standardized cooperating fastener arrangement such that the infill panels 22, 24, 26 may be interchangeably secured in the openings 14.

The interchangeable infill panels may include one of a flat wall surface 22, a windowed wall surface 24, or a doorway wall surface 26, with the windowed 24 and doorway 26 wall surfaces having a preformed opening for mounting one of a window assembly and a door assembly respectively. The openings 14 created in the container 10 are designed to receive the standardized interchangeable infill panels 22, 24, 26, or no panel at all. The infill panels 22, 24, 26 may be formed in various configurations and combinations of open walls, doors, windows or separation walls.

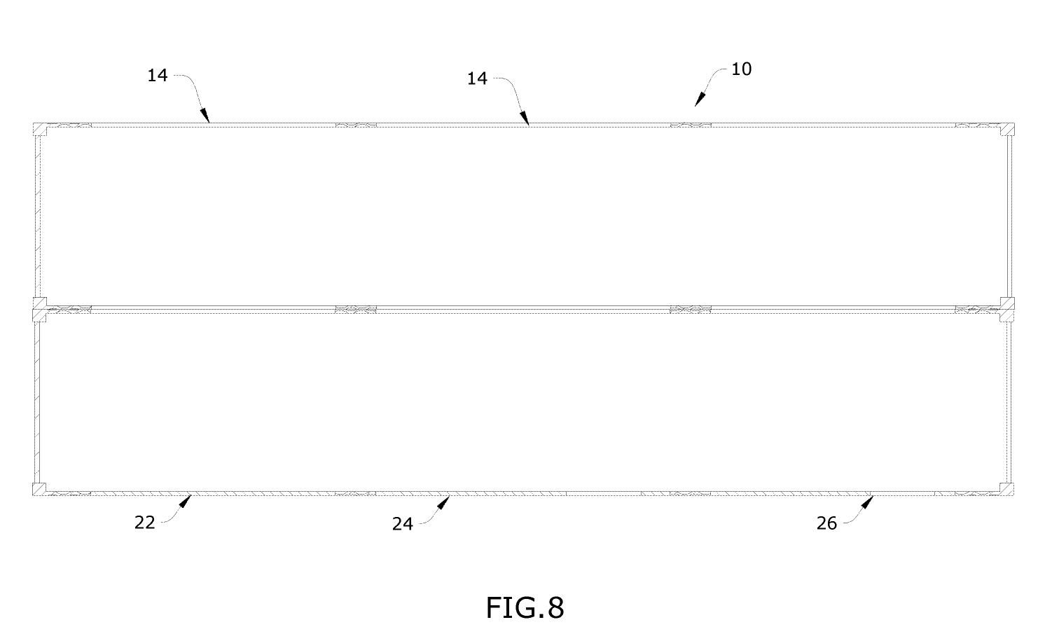

As seen in reference to FIGS. 7 and 8, by various arrangements of the standardized modules 10 can be configured side by side, end to end, staggered horizontally or vertically. Accordingly, a wide variety of floor plan configurations and architectural spaces and volumes can be achieved. Because the modules 10 are standardized, changes to the building configuration and layout are simple to implement, if needed, just by changing out an infill panel 22, 24, 26 to accommodate a new layout or additional modules.

The SGUBMs can be fabricated in various manners. For example, in reference to FIGS. 6-9, a container 10 may be built at the point of origin when it is initially fabricated. The container 10 may be provided with the side 22 and end wall openings fabricated and then infilled with a standardized side 22 and end wall 22 material meeting specifications for transport as a cargo container. Alternatively, a used container can be obtained at the point of use and the container modified by creating the openings 14 and installation of reinforcement members 16, 18, 20.

In the case of the point of origin (original fabrication) the container 10 would be certified according to CSC requirements for use as a shipping container and put into a fleet for one trip to its point of use. The container 10 may be filled with the selected infill panels 16, 28, 20, as well as any interior fixtures, furnishings, and equipment intended for the end use of the module 10. For example the module(s) may be configured as one of an office, a medical clinic, a dental clinic, a maintenance facility, a store, or lodging quarters. The interior fixtures may include electrical and communications wiring, plumbing, heating ventilation and air conditioning HVAC, and the like. The furnishings may include desks, chairs, lamps, tables, cabinets, automation data processing equipment, and the like. Once at the destination, the infill panels 16, 18, 20 can either be left in place or other types of infill panels 22, 24, 26 may be interchanged in accordance with the architectural plan for the construction.

If a used container 10 is modified then the standard openings 14 are cut in a normal container 10 pulled from the fleet. Reinforcement members 16, 18, 20 may then be added locally to achieve the standard module. Because the openings 14, reinforcement members 16, 18, 20 and infill panels 22, 24, 26 are all standardized and uniform the module itself becomes interchangeable and can easily be dismantled and reused on another building either on its current site or at another site.

The universal nature of the modules allows complete interchangeability just by changing out the infill panels 22,24, 26. Retaining the intermodal design of the basic container 10 also allows the use of standard transport and hoisting equipment. Just as the CSC has strict manufacturing guidelines, the base SGUBM is structurally engineered to ensure structural safety and uniformity in fabrication and quality control.

A key element to versatile reconfiguration is the contemplated use of the infill panels 22,24, 26. As indicated, the infill panels 22,24, 26 can be fabricated to any combination of doors, windows or openings but the basic container module 10 remains the same. The structural frame of the Universal Module itself is not impacted regardless of the type of infill panel 22, 24, 26 used or if no infill panel is used.

The infill panels 22, 24, 26 and modules 10 are completely interchangeable and are used just like standard building blocks to create the desired structural building space. The basic approach is to take the floor plan layout for the building to be designed and arrange the standard building modules to match the desired layout. The infill panels 22, 24, 26 would be used to create detailed openings such as windows, door and other cased openings.

It should be understood, of course, that the foregoing relates to exemplary embodiments of the invention and that modifications may be made without departing from the spirit and scope of the invention as set forth in the following claims.

What is claimed is:

1. A structure building module, comprising:
an intermodal shipping container, comprising one or more primary apertures defined therein,
a frame surrounding the primary aperture wherein the fame is defined by a plurality of structural support members; and
an infill panel, received in at least one of the frames.

2. The structure building module of claim 1, wherein the infill panel is configured with a window opening.

3. The structure building module of claim 2, further comprising:
a window assembly received in the window opening.

4. The structure building module of claim 1, wherein the infill panel is configured with a door opening.

5. The structure building module of claim 4, further comprising:
a door assembly received in the door opening.

6. The structure building module of claim 1, wherein each of the primary apertures have a corresponding dimension.

7. The structure building module of claim 6, wherein the infill panel is dimensioned to fit the one or more primary apertures.

8. The structure building module of claim 7, the frame and infill panel is configured with a standardized cooperating fastener arrangement such that the infill panel may be interchangeably secured in the one or more primary apertures.

9. The structure building module of claim 1, further comprising:
a plurality of intermodal shipping containers configured for interconnection to each other.

10. A method of forming a building structure from an intermodal shipping container, comprising:
modifying the intermodal shipping container by creating one or more primary apertures in a sidewall of the intermodal shipping container; and
framing the one or more primary apertures with a plurality of frame members.

11. The method of claim 10, further comprising:
forming an infill panel dimensioned to be received in the one or more primary apertures.

12. The method of claim 11, further comprising:
installing the infill panel in the one or more primary apertures.

13. The method of claim 11, further comprising:
forming a standardized fastener pattern in the plurality of frame members.

14. The method of claim 13, further comprising:
forming a corresponding fastener pattern in the infill panel, wherein the corresponding fastener pattern is configured for cooperative engagement of a fastener with the standardized fastener pattern of the frame members.

15. The method of claim 10, further comprising:
forming one of a door opening or a window opening in a surface of the infill panel.

16. The method of claim 15, further comprising:
installing one of a door assembly or a window assembly in the door or the window opening.

17. The method of claim 13, further comprising:
forming a plurality of interchangeable infill panels, wherein each of the plurality of interchangeable infill panels have dimensions corresponding to the one or more primary apertures.

18. The method of claim 17, further comprising:
joining a plurality of modified intermodal shipping containers to form a larger building structure.

19. The method of claim 18, further comprising:
aligning the primary apertures of a first intermodal shipping container to overlap at least a portion of the primary apertures of a subsequent intermodal shipping container.
